(19) United States
(12) Patent Application Publication
(10) Pub. No.: US 2024/0095572 A1
(43) Pub. Date: Mar. 21, 2024

(54) QUANTUM CIRCUIT LEARNING SYSTEM, QUANTUM CIRCUIT LEARNING METHOD, QUANTUM INFERENCE SYSTEM, QUANTUM CIRCUIT, AND QUANTUM-CLASSICAL HYBRID NEURAL NETWORK

(71) Applicant: KABUSHIKI KAISHA TOSHIBA, Tokyo (JP)

(72) Inventors: Yasutaka NISHIDA, Tama Tokyo (JP); Fumihiko AIGA, Kawasaki Kanagawa (JP)

(73) Assignee: KABUSHIKI KAISHA TOSHIBA, Tokyo (JP)

(21) Appl. No.: 18/175,702

(22) Filed: Feb. 28, 2023

(30) Foreign Application Priority Data
Sep. 20, 2022 (JP) 2022-149292

(51) Int. Cl. G06N 10/60; G06N 10/40

(52) U.S. Cl. CPC G06N 10/60; G06N 10/40

(57) ABSTRACT

Quantum circuit includes 1st block and 2nd block. 1st block includes gate operation layer and measurement layer. Gate operation layer includes encoding gate parameterized with encoding parameter including encoded input information for constructing 1st HF state, and transformation gate parameterized with learning parameter for transforming 1st HF state into 1st quantum state. Measurement layer outputs measurement value of 1st quantum state. 2nd block includes gate operation layer. Gate operation layer includes 2nd encoding gate parameterized with encoding parameter including encoded measurement value for constructing 2nd HF state, and transformation gate parameterized with learning parameter for transforming 2nd HF state into 2nd quantum state.

### CROSS-REFERENCE TO RELATED APPLICATIONS

This application is based upon and claims the benefit of priority from Japanese Patent Application No. 2022-149292, filed Sep. 20, 2022, the entire contents of which are incorporated herein by reference.

### FIELD

Embodiments described herein relate generally to a quantum circuit learning system, a quantum circuit learning method, a quantum inference system, a quantum circuit, and a quantum-classical hybrid neural network.

### BACKGROUND

In recent years, the development of gate-type quantum computers has progressed significantly, and quantum computing using quantum properties can be implemented by various methods although it is on a small scale. These quantum computers are called noisy intermediate-scale quantum (NISQ) devices, and are regarded as an important first step of a milestone for a quantum computer implementing future error correction. Research utilizing NISQ is currently actively conducted, and in particular, an algorithm called variational quantum eigensolver (VQE) (see Non-Patent Literature 1 (A. Peruzzo, J. McClean, P. Shadbolt, M.-H. Yung, X.-Q. Zhou, P. J. Love, A. Aspuru-Guzik, and J. L. O'Brien, “A variational eigenvalue solver on a photonic quantum processor,” Nature Communications, 5, article number: 4213, 2014.)) is expected to be applied to quantum chemistry computing as a method of hybridizing and utilizing a quantum computer and a classical computer. However, there are many problems in implementing the VQE for practical problems such as drug discovery and material development. Specifically, in order to obtain a highly accurate result with the VQE, it is necessary to alternately perform measurement sampling in an NISQ device and a classical computer a large number of times. Therefore, currently, various proposals have been made to reduce the calculation cost by reducing the number of measurements, improving error mitigation, and the like.

### BRIEF DESCRIPTION OF THE DRAWINGS

FIG. 1 is a block diagram illustrating an example of a configuration of a quantum circuit learning system.

FIG. 2 is a block diagram illustrating an example of a configuration of a quantum circuit.

FIG. 3 is a schematic diagram of a circuit configuration of the quantum circuit.

FIG. 4 is a schematic diagram of a circuit configuration of an SYMP illustrated in FIG. 3.

FIG. 5 is a schematic diagram of a circuit configuration of the SYMP illustrated in FIG. 4 in quantum gate notation.

FIG. 6 is a diagram illustrating a processing procedure of quantum circuit learning processing by the quantum circuit learning system.

FIG. 7 is a block diagram illustrating an example of a configuration of a quantum inference system.

FIG. 8 is a diagram illustrating a processing procedure of quantum inference processing by the quantum inference system.

FIG. 9 is a schematic diagram of a circuit configuration of a quantum circuit according to Example 1 in quantum gate notation.

FIG. 10 is a graph illustrating numerical simulation results according to Example 1.

FIG. 11 is another graph illustrating numerical simulation results according to Example 1.

FIG. 12 is a graph illustrating numerical simulation results of an H₂O molecule according to Example 2.

FIG. 13 is a graph illustrating numerical simulation results of an NH₃ molecule according to Example 2.

FIG. 14 is a graph illustrating an error between the numerical simulation results of the H₂O molecule by CASCI illustrated in FIG. 12 and the numerical simulation results of the H₂O molecule by HQCNN illustrated in FIG. 12.

FIG. 15 is a graph illustrating an error between the numerical simulation results of the NH₃ molecule illustrated in FIG. 13 by CASCI and the numerical simulation results of the NH₃ molecule by HQCNN illustrated in FIG. 13.

FIG. 16 is a graph illustrating numerical simulation results of an H₃ molecule according to a comparative example of Example 3.

FIG. 17 is a graph illustrating numerical simulation results of the H₃ molecule according to Example 3.

### DETAILED DESCRIPTION

In a series of studies for reducing the calculation cost of the VQE, in 2020, Xia & Kais et al. proposed a quantum-classical hybrid neural network disclosed in Non-Patent Literature 2 (R. Xia and S. Kais, “Hybrid Quantum-Classical Neural Network for Calculating Ground State Energies of Molecules” Entropy 22, 828 (2020)) that enables estimation of a ground-state potential energy surface (PES) of a small molecule with high accuracy. Their method is a method of configuring a surrogate model of the VQE that substitutes a conventional VQE calculation procedure with a neural network using a quantum circuit. According to the proposed method, variational optimization for each molecular structure, which has been conventionally required in the calculation of the PES using the VQE, is unnecessary. Therefore, the calculation cost can be reduced, and a highly accurate PES estimation value can be obtained on the NISQ device. However, in the method disclosed in Non-Patent Literature 2, since a parameterized quantum circuit having too high expressive power is used to solve the task of quantum chemistry computing, it is reported that highly accurate inference is possible in the simple two-molecule system disclosed in Non-Patent Literature 2, but the inference accuracy decreases in a case where the number of molecules or the number of qubits increases. Although it is necessary to sufficiently lower the cost function in order to increase the accuracy of inferring the energy of an H₃ molecule by the method of Non-Patent Literature 2, this requires many iterative calculations, and as a result, the calculation method is not efficient, and it is difficult to use the method for a practical molecule.

A quantum circuit learning system according to an embodiment includes a quantum computing unit and a learning control unit. The quantum computing unit applies input information to a quantum circuit that performs a quantum gate operation on a plurality of qubits to acquire output information corresponding to the input information. The learning control unit updates a learning parameter of the quantum circuit based on a difference between the output information and ground truth information. The quantum circuit includes a first block circuit and a second block circuit concatenated to the first block circuit. The first block circuit includes: a first gate operation layer including a first encoding gate that is a quantum gate parameterized with a first encoding parameter in which the input information is encoded and which is for constructing a first Hartree-Fock state, and a first transformation gate that is a quantum gate parameterized with the learning parameter for transforming the first Hartree-Fock state into a first quantum state; and a measurement layer that outputs a measured value of the first quantum state. The second block circuit includes: a second gate operation layer including a second encoding gate parameterized with a second encoding parameter in which the measured value is encoded and which is for constructing a second Hartree-Fock state, and a second transformation gate parameterized with the learning parameter for transforming the second Hartree-Fock state into a second quantum state; and an output layer that outputs the second quantum state as the output information.

Hereinafter, a quantum circuit learning system, a quantum circuit learning method, a quantum inference system, a quantum circuit, and a quantum-classical hybrid neural network according to the present embodiment will be described with reference to the drawings.

### Quantum Circuit Learning System

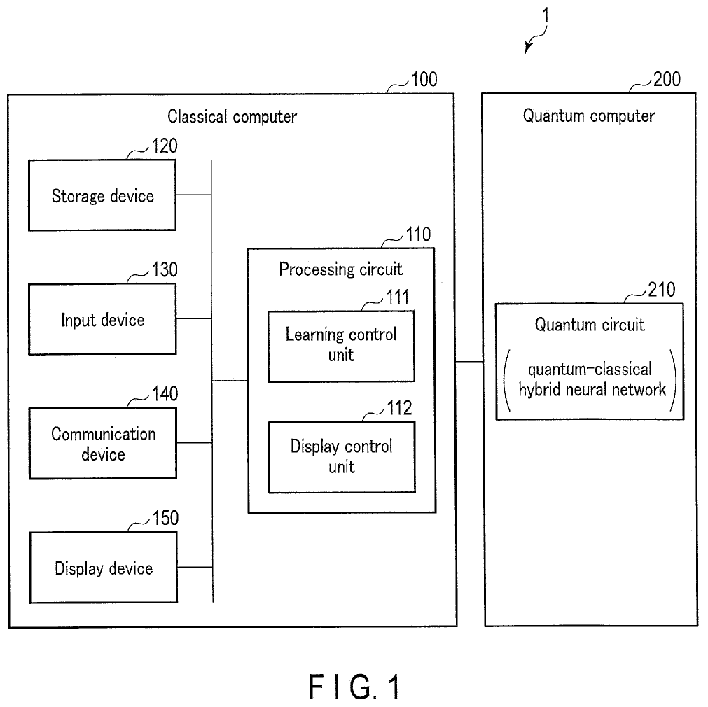

FIG. 1 is a block diagram illustrating an example of a configuration of the quantum circuit learning system 1 according to the present embodiment. As illustrated in FIG. 1, the quantum circuit learning system 1 includes a classical computer 100 and a quantum computer 200. The classical computer 100 and the quantum computer 200 are connected to each other so as to be able to communicate information with each other by wire or wirelessly.

The classical computer 100 is a computer that processes binary classical bits. The classical computer 100 is a computer including a processing circuit 110, a storage device 120, an input device 130, a communication device 140, and a display device 150. Information communication is performed between the processing circuit 110, the storage device 120, the input device 130, the communication device 140, and the display device 150 via a bus. Note that the storage device 120, the input device 130, the communication device 140, and the display device 150 are not essential components, and can be omitted as appropriate.

The processing circuit 110 includes a processor such as a central processing unit (CPU) and a memory such as a random access memory (RAM). The processing circuit 110 includes a learning control unit 111 and a display control unit 112. The processing circuit 110 implements each function of each of the units 111 and 112 by executing a quantum circuit learning program. The quantum circuit learning program is stored in a non-transitory computer-readable recording medium such as the storage device 120. The quantum circuit learning program may be implemented as a single program that describes all the functions of the units 111 and 112 described above, or may be implemented as a plurality of modules divided into several functional units. Each of the units 111 and 112 may be implemented by an integrated circuit such as an application specific integrated circuit (ASIC)) or a field programmable gate array (FPGA). In this case, the units 111 to 114 may be mounted on a single integrated circuit, or may be individually mounted on a plurality of integrated circuits.

The learning control unit 111 controls quantum circuit learning for a quantum circuit 210 implemented in the quantum computer 200. Specifically, the learning control unit 111 acquires learning information. The learning information includes a plurality of learning samples. Each learning sample includes input information and ground truth information corresponding to the input information. The learning control unit 111 provides the input information to the quantum circuit 210. The input information is transformed into output information by the quantum circuit 210. The learning control unit 111 updates a circuit parameter of the quantum circuit 210 based on a difference between the output information and the ground truth information. The learning control unit 111 performs the update processing until a stop condition is satisfied. When the stop condition is satisfied, the learning control unit 111 determines the circuit parameter. Thus, the quantum circuit 210 is completed. Note that the circuit parameter is an example of a parameter for controlling a quantum gate included in the quantum circuit 210. In the present embodiment, the circuit parameter to be updated is referred to as a learning parameter.

The display control unit 112 causes the display device 150 to display various types of information. For example, the display control unit 112 displays the input information, the output information, the ground truth information, and the like.

The storage device 120 includes a read only memory (ROM), a hard disk drive (HDD), a solid state drive (SSD), an integrated circuit storage device, or the like. The storage device 120 stores the quantum circuit learning program and the like.

The input device 130 inputs various commands from an operator. As the input device 130, a keyboard, a mouse, various switches, a touch pad, a touch panel display, and the like can be used. An output signal from the input device 130 is supplied to the processing circuit 110. Various commands from the operator may be input not by the input device 130 included in the classical computer 100 but by an input device provided in another classical computer connected via the communication device 140.

The communication device 140 is an interface for performing information communication with an external device such as the quantum computer 200 connected to the classical computer 100 by wire or wirelessly.

The display device 150 displays various types of information under control by the display control unit 112. As the display device 150, a cathode-ray tube (CRT) display, a liquid crystal display, an organic electroluminescence (EL) display, a light-emitting diode (LED) display, a plasma display, or any other display known in the art can be appropriately used. Furthermore, the display device 150 may be a projector.

The quantum computer 200 is a computer that has the quantum circuit 210 implemented therein that performs a quantum gate operation on a plurality of qubits, and performs quantum computing using the quantum circuit 210. As a method of implementing a qubit and a quantum gate by the quantum circuit 210, any method such as a superconducting circuit method, an ion trap method, a quantum dot method, or an optical lattice method may be used. It is assumed that the quantum computer 200 has various types of hardware for implementing an environment according to the method of implementing a qubit and a quantum gate. Although not illustrated in FIG. 1, the quantum computer 200 may include a storage device, an input device, a communication device, a display device, and the like in addition to a processing circuit for performing various types of information processing using classical bits. The quantum computer 200 is an example of the quantum computing unit.

The quantum computer 200 receives the input information from the classical computer 100, and inputs the input information to the quantum circuit 210 that performs a quantum gate operation on a plurality of qubits. The quantum circuit 210 transforms the input information into the output information. The quantum computer 200 acquires the output information from the quantum circuit 210. The quantum computer 200 transmits the acquired output information to the classical computer 100.

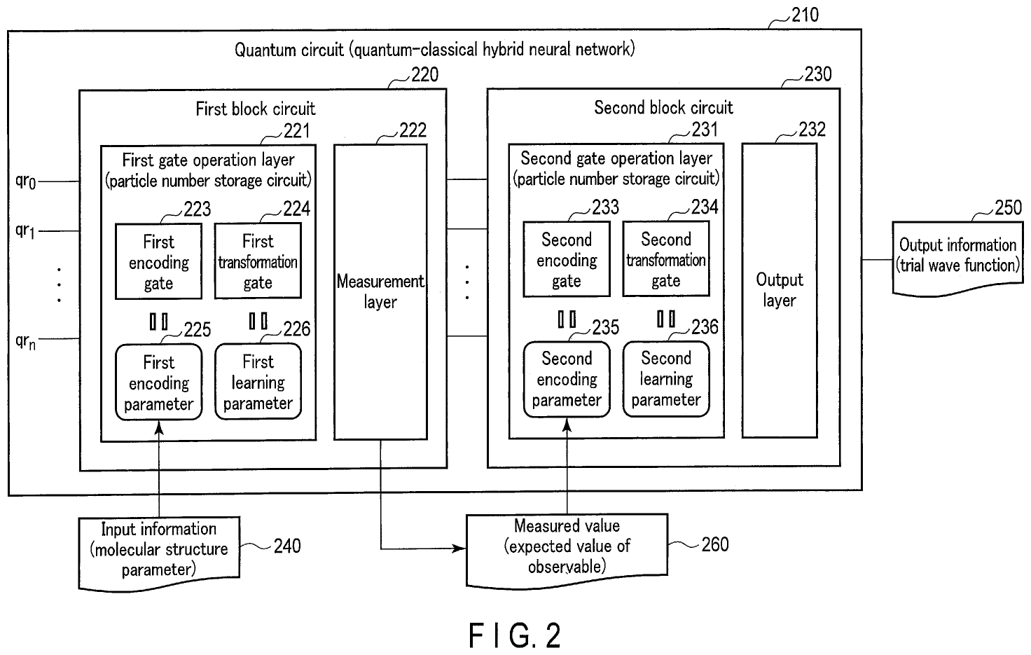

FIG. 2 is a block diagram illustrating an example of a configuration of the quantum circuit 210. The quantum circuit 210 is a parameterized quantum circuit (quantum circuit with a parameter) including a sequence of quantum gates controlled by the learning parameter. Since the learning parameter of the parameterized quantum circuit is trained by quantum circuit learning, the parameterized quantum circuit is also called a quantum neural network. Since the quantum circuit 210 according to the present embodiment performs quantum computing by the quantum gates and performs a classical measurement operation, the quantum circuit 210 can also be referred to as a quantum-classical hybrid neural network.

As illustrated in FIG. 2, the quantum circuit 210 includes n (n is a natural number of 3 or more) qubits. n may be appropriately set according to the scale such as the number of molecules, the number of atoms, the number of electrons, and the number of electron orbitals of a processing target molecule. The quantum circuit 210 performs quantum computing on the n qubits to construct output information 250 from input information 240. The type of the input information 240 can be arbitrarily selected according to the task of the quantum circuit 210. It is assumed that the task of the quantum circuit 210 according to the present embodiment is quantum chemistry computing, and that the input information 240 is a molecular structure parameter that is a parameter defining the molecular structure of the processing target molecule. As the molecular structure parameter, coordinates of each atom constituting the processing target molecule, a distance (bond length) between atoms, an angle (bond angle) between bonds, and the like are used.

It can be said that the quantum circuit 210 is a quantum-classical hybrid neural network having a repetitive structure of block circuits each including a quantum circuit in which quantum information is subjected to processing items related to a Hartree-Fock state, a parameterized quantum circuit, and a measurement layer in this order. Specifically, as illustrated in FIG. 2, the quantum circuit 210 includes a first block circuit 220 and a second block circuit 230 concatenated to the first block circuit 220. The first block circuit 220 includes a first gate operation layer 221 and a measurement layer 222. The first gate operation layer 221 has a sequence of first encoding gates 223 and a sequence of first transformation gates 224. Each of the first encoding gates 223 is a quantum gate parameterized with a first encoding parameter 225 in which the input information 240 is encoded and which is for constructing a first Hartree-Fock state. The first encoding parameter 225 is a circuit parameter, but is not a parameter to be updated by quantum circuit learning. The first encoding parameter 225 is set to a value corresponding to the input information 240. The Hartree-Fock state means a quantum state when electrons are filled in order from an electron orbit having a low energy level. The quantum state is represented by the n qubits. Each of the first transformation gates 224 is a quantum gate parameterized with a first learning parameter 226 for transforming the first Hartree-Fock state into a first quantum state. The measurement layer 222 outputs a measured value 260 of the first quantum state. As the measured value 260, an expected value of an observable represented by the first quantum state is output.

The second block circuit 230 includes a second gate operation layer 231 and an output layer 232. The second gate operation layer 231 has a sequence of second encoding gates 233 and a sequence of second transformation gates 234. Each of the second encoding gates 233 is a quantum gate parameterized with a second encoding parameter 235 in which the measured value 260 output by the measurement layer 222 is encoded and which is for constructing a second Hartree-Fock state. The second encoding parameter 235 is a circuit parameter, but is not a parameter to be updated by quantum circuit learning. The second encoding parameter 235 is set to a value corresponding to the measured value 260. Each of the second transformation gates 234 is a quantum gate parameterized with a second learning parameter 236 for transforming the second Hartree-Fock state into a second quantum state. The output layer 232 outputs the second quantum state as the output information 250. As the output information 250, a trial wave function represented by the second quantum state is output. Note that the first gate operation layer 221 and the second gate operation layer 231 may have the same quantum gate configuration or different quantum gate configurations.

As described above, the first block circuit 220 and the second block circuit 230 are connected to each other via the measured value 260 obtained by the measurement layer 222. With the above configuration, the second encoding gates 233 can encode the quantum state (Hartree-Fock state) represented by the measured value 260 into the qubits. Each of the first gate operation layer 221 and the second gate operation layer 231 is implemented by a particle preserving circuit called an A gate. The particle preserving circuit is an ansatz that preserves the number of particles between the input quantum state and the output quantum state. That is, each of the first gate operation layer 221 and the second gate operation layer 231 performs the quantum gate operation with the transformation gates controlled by the learning parameter while preserving the number of particles for the input Hartree-Fock state.

By adopting this configuration, the quantum circuit 210 can have a circuit configuration specialized for quantum chemistry computing with the Hartree-Fock state as an initial input, as compared with Non-Patent Literature 2 having high versatility. As a result, it is possible to improve convergence in a system having a large number of atoms, to apply the system to an actual practical system, to reduce the number of circuit parameters, and to reduce the calculation cost of quantum circuit learning associated therewith.

Next, the quantum circuit 210 will be described in detail.

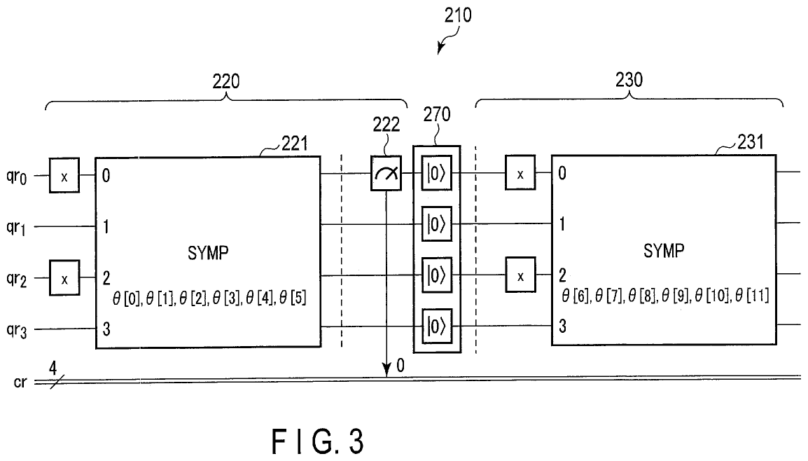

FIG. 3 is a schematic diagram of a circuit configuration of the quantum circuit 210. The quantum circuit 210 illustrated in FIG. 3 is, for example, a quantum-classical hybrid neural network that performs quantum computing on 4 (n=4) qubits qrₖ (k=0, 1, 2, and 3). As described above, the quantum circuit 210 includes the first block circuit 220 and the second block circuit 230.

The first block circuit 220 includes the parameterized quantum circuit (SYMP) 221 and the measurement layer 222. The SYMP 221 includes the sequence of quantum gates that construct the first Hartree-Fock state and the sequence of transformation gates that transform the first Hartree-Fock state into the first quantum state. The encoding gates and the transformation gates are implemented by rotation gates that perform a quantum gate operation of rotating a quantum state around a predetermined axis by an angle θ. Each of the rotation gates is controlled by a rotation angle parameter θ which is an example of a circuit parameter.

In the example of FIG. 3, it is assumed that rotation angle parameters θ included in the SYMP 221 are, for example, six types of θ(0) to θ(5). As described above, the rotation angle parameters θ for controlling the encoding gates are encoding parameters, and the rotation angle parameters θ for controlling the transformation gates are learning parameters θ. The measurement layer 222 is provided at a subsequent stage of the SYMP 221 and measures at least one of the four qubits qrₖ. In the example of FIG. 3, the measurement layer 222 measures the first qubit qr₀.

The second block circuit 230 is provided at a subsequent stage of the first block circuit 220 with an initialization layer 270 interposed therebetween. The initialization layer 270 includes a quantum gate that initializes all the qubits qrₖ to a quantum state |0>. In the example illustrated in FIG. 3, the second block circuit 230 is concatenated via the first qubit gr₀ measured by the measurement layer 222.

The second block circuit 230 includes the parameterized quantum circuit (SYMP) 231 and the output layer. The SYMP 231 includes the sequence of quantum gates that construct the second Hartree-Fock state and the sequence of transformation gates that transform the second Hartree-Fock state into the second quantum state. The encoding gates and the transformation gates are controlled by the rotation angle parameters θ. In the example illustrated in FIG. 3, it is assumed that rotation angle parameters θ included in the SYMP 231 are, for example, six types of θ(6) to θ(11). Although not illustrated in FIG. 3, the output layer is provided at a subsequent stage of the SYMP 231 and outputs a quantum state represented by the qubits qrₖ as a trial wave function. Unlike the measurement layer 222, the output layer does not perform a measurement operation.

Hereinafter, in a case where the SYMP 221 and the SYMP 231 are not particularly distinguished, each of the SYMP 221 and the SYMP 232 are simply referred to as an SYMP.

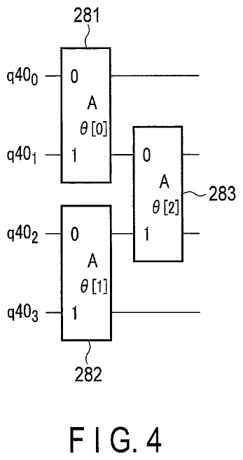

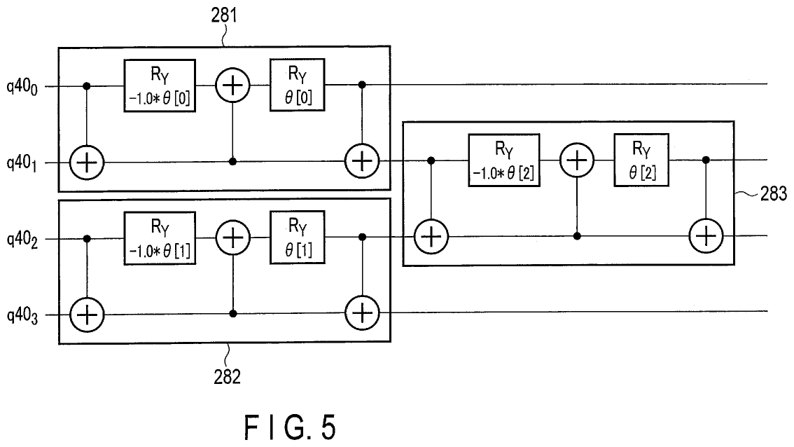

FIG. 4 is a schematic diagram of a circuit configuration of the SYMP illustrated in FIG. 3. FIG. 5 is a schematic diagram of a circuit configuration of the SYMP illustrated in FIG. 4 in quantum gate notation. The SYMP includes particle preserving circuit 281, 282, and 283 called A gates. Each of the particle preserving circuit 281, 282, and 283 performs computing processing on two qubits. As an example, the particle preserving circuit 281 is arranged across the first qubit and the second qubit, the particle preserving circuit 282 is arranged across the third qubit and the fourth qubit, and the particle preserving circuit 283 is arranged across the second qubit and the third qubit. The particle preserving circuit 281, 282, and 283 include a series of a plurality of rotation gates. Each of particle preserving circuit 281, 282, and 283 includes at least one rotation angle parameter θ. Each of the particle preserving circuit 281, 282, and 283 may include only one rotation angle parameter when a calculation target to be subjected to calculation satisfies time reversal symmetry. As an example, it is assumed that the rotation angle parameter θ(0) is given to the particle preserving circuit 281, the rotation angle parameter θ(1) is given to the particle preserving circuit 282, and the rotation angle parameter θ(2) is given to the particle preserving circuit 283.

FIG. 5 is a schematic diagram of a circuit configuration of the SYMP illustrated in FIG. 4 in quantum gate notation. Each of the SYMPs illustrated in FIGS. 4 and 5 has four qubits and includes three types of rotation angle parameters θ(0) to θ(2). Each of the SYMPs illustrated in FIG. 3 is configured by repeating a block including the particle preserving circuit 281, 282, and 283 illustrated in FIGS. 4 and 5 m times. In this case, the number of rotation angle parameters θ included in each SYMP is 3 m. The SYMP illustrated in FIG. 3 includes six types of rotation angle parameters θ(0) to θ(5), and thus m=2.

More generally, when n qubits are prepared, the number of parameters included in each SYMP block is (n−1)m. In general, the SYMP formed by preparing n qubits and repeating the particle preserving circuit 281, 282, and 283 illustrated in FIG. 4 m times is expressed by the following Equation (1).

SYMP=A(θ0)A(θ1)A(θ2) . . . A(θ(n−1)m−1) (1)

At least one encoding parameter included in the SYMP is a part of rotation angle parameters θ₀ to θₙ₋₁ in Equation (1). As an example, the encoding parameter can be θ₀ of A(θ₀) in the above Equation (1). The remaining rotation angle parameters such as θ₁ and θ₂ are set as learning parameters. Any rotation angle parameter among the n rotation angle parameters θ₀ to θₙ₋₁ may be selected as the encoding parameter, and the number of encoding parameters can also be changed according to the degree of freedom of the calculation target. The number No of remaining total rotation angle parameters included in the SYMP is (n−1)m−Ne, where Ne is the number of encoding parameters. That is, the number of learning parameters for constructing a quantum state from a Hartree-Fock state included in the SYMP is No.

As illustrated in FIG. 5, the particle preserving circuit 281 includes a rotation gate Ry having −1.0*θ(0) as an encoding parameter and a rotation gate Ry having θ(0) as an encoding parameter. The particle preserving circuit 282 includes a rotation gate Ry having −1.0*θ(1) as a learning parameter and a rotation gate Ry having θ(1) as a learning parameter. The particle preserving circuit 283 includes a rotation gate Ry having −1.0*θ(2) as a learning parameter and a rotation gate Ry having θ(2) as a learning parameter.

In each of the first block circuit 220 and the second block circuit 230, the rotation angle parameters included in the SYMP (gate operation layer) are divided into an encoding parameter and a learning parameter according to the above rule. Values of the rotation angle parameters are determined by quantum circuit learning. The encoding parameter of the first block circuit 220 is set to the molecular structure parameter itself that is the input information or to a value based on the molecular structure parameter. The encoding parameter of the second block circuit 230 is set to the measured value itself measured by the measurement layer 222 or to a value based on the measured value.

In the measurement layer 222, Ne encoding parameters are measured. The measurement layer 222 uses a quantum state transformed from a Hartree-Fock state to perform processing of outputting, as a measured value, an expected value of an observable configured by an arbitrary tensor product of Pauli operations I, X, Y, and Z in the n qubits for the quantum state. As an example, when Ne=1 in FIG. 3, the expected value of the Pauli operator of the Z basis of the first qubit is measured in the measurement layer 222. The measurement may be performed on the second qubit, the third qubit, or the fourth qubit.

The quantum circuit 210 calculates ground-state energy for an arbitrary system of the calculation target based on learning information of some systems of the calculation target. The precondition will be described below.

The quantum computer performs quantum computing based on a quantum circuit U(θ) including a unitary operator. The parameter θ is a generally N-dimensional vector representing the quantum circuit. In the case of n qubits, the quantum circuit U(θ) and the quantum state ψ(θ) are associated with each other by the following

$$Equation ( 2 )$$

$${{ψ ( Θ ) = U ( Θ ) \vert 0 〉}^{{⊗}_{n}} \\ \vert 0 〉}^{{⊗}_{n}} : Initial quantum state . \qquad ( 2 )$$

If the Hamiltonian H of the calculation target is given, the expected value E(θ) can be calculated according to the following Equation (3) using the quantum state |ψ(θ)>.

E(θ)=<ψ(θ)|H|ψ(θ)> (3)

The VQE described in Non-Patent Literature 1 is an algorithm that minimizes an expected value E(θ) obtained using a quantum computer with respect to θ.

The quantum-classical hybrid neural network is a surrogate model of the VQE, prepares a calculation target and a part of its Hamiltonian as D={Xᵢ, Hᵢ} (the subscript i represents a number of a learning sample), and executes an algorithm for minimizing a cost function f expressed by the following Equation (4) using D as a learning sample.

$$f = {\sum }_{j} 〈 ψ ( θ ) \vert {H}_{j} \vert ψ ( θ ) 〉 / {\sum }_{j} 1 = {\sum }_{j} {E}_{i} ( θ ) / {\sum }_{j} 1 \qquad ( 4 )$$

The Hamiltonian H is given in a second quantization display in which the state “0” of the qubit is regarded as an unoccupied orbit, the state “1” of the qubit is regarded as an occupied orbit, and the quantum state is expressed by the occupied state of the spin orbit. However, it is not possible to calculate the Hamiltonian by the second quantization on the quantum circuit, and the Hamiltonian is transformed into a qubit Hamiltonian in which creation and annihilation operators are rewritten with a linear combination of the Pauli operators. As a representative transformation method, there is a Jordan-Wigner transformation [Jordan and Wigner (1928)], and some other transformation methods (Bravi and Kitaev (2005); Seeley and Love (2012)) are known. By using these transformation methods, the Hamiltonian is given by a tensor product of any weighted Pauli operators expressed by the following Equation (5).

$$ℋ = {\sum }_{k} {h}_{k} {P}_{k} = {\sum }_{k} {h}_{k} {\prod }_{k} {σ}_{l}^{k} \qquad ( 5 )$$

In Equation (5), σₗϵ{I, X, Y, Z}, and I, X, Y, and Z are an identity operator and Pauli operators of X, Y, and Z components, respectively. At the time of learning of the quantum-classical hybrid neural network, the input value Xᵢ of the learning sample D={Xᵢ, Hᵢ} is classical data, and needs to be encoded into a quantum state that can be processed by the quantum circuit, similarly to the Hamiltonian expressed by Equation (5).

In general, in the case of n qubits, the encoding of the input value Xᵢ which is classical data can be expressed by a gate operation of the following Equation (6). Here, i is a number of a qubit, fᵢ is an arbitrary classical function acting on the i-th qubit, and gᵢ is an arbitrary single qubit gate having a result output from fᵢ as a parameter.

G=⊗ᵢ₌₀ⁿ⁻¹gᵢ(fᵢ(Xᵢ)) (6)

The initial quantum state function |ψ_{encoded}> expressed using the following Equation (7) can be configured by preparing the initial state and performing encoding expressed in Equation (4).

s′ₓ^{new}=αsₓ+(1−α)s′ₓ^{old} (7)

The quantum state is obtained as |ψ(θ)>=U(θ)|ψ_{encoded}> by causing the quantum circuit U(θ) to act on the initial quantum state function |ψ_{encoded}>.

The cost function f expressed by Equation (4) can be calculated from the learning sample D={Xᵢ, Hᵢ} by the procedure using Equations (5) and (6) described above.

In a quantum-classical hybrid neural network applied to a two-atom molecular system represented by a hydrogen molecule, fᵢ=I and gᵢ=R_{y}H are used, and a bond distance between two atoms is used as Xᵢ. In such a quantum-classical hybrid neural network, a real-amplitude 2-local type including a Ry gate and a CNOT gate is used for the quantum circuit U(θ), and a quantum circuit including a measurement layer interposed is configured in order to give nonlinearity to the quantum circuit including the unitary operator.

In the quantum-classical hybrid neural network described above, the expected value of the Pauli operator of the Z component obtained using the quantum state ψ(θ) is measured, a new initial quantum state |ψ′_{encoded}>=G′|ψ$(θ)> obtained from G′ obtained by substituting the measured value into Xᵢ of Equation (6) and the quantum state ψ(θ) is configured, a quantum state |ψ′(θ′)>=U(θ′)|ψ′_{encoded}> is newly configured from |ψ′_{encoded}> and U(θ′), and the cost function f expressed by Equation (4) is calculated using |ψ′(θ′)>, thereby configuring the quantum circuit including the measurement layer interposed.

For example, in a quantum-classical hybrid neural network applied to a diatomic molecular system represented by a hydrogen molecule, the learning sample D={Xᵢ, Hᵢ} is prepared, U(θ) and U(θ′) and ψ(θ) and ψ(θ′) are configured by the above procedure, and learning for minimizing the cost function f expressed by Equation (4) is performed on θ and θ′, thereby estimating energy of a hydrogen molecule with an arbitrary interatomic distance and calculating a potential energy surface of the hydrogen molecule.

Next, quantum circuit learning processing by the quantum circuit learning system 1 will be described.

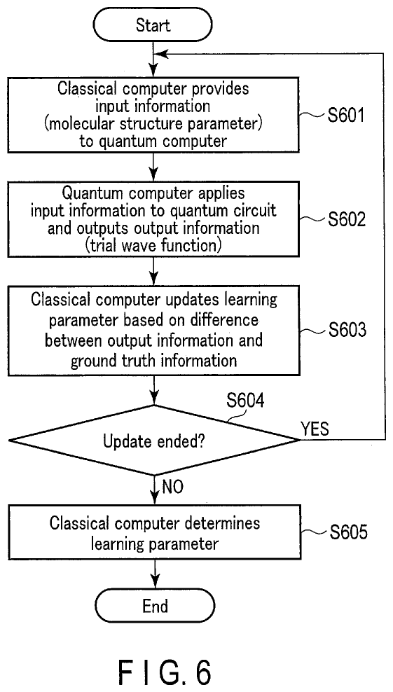

FIG. 6 is a diagram illustrating a processing procedure of the quantum circuit learning processing by the quantum circuit learning system 1. As illustrated in FIG. 6, the classical computer 100 provides input information to the quantum computer 200 (step S601). In step S601, the input information of a plurality of learning samples among a plurality of learning samples to be used for quantum circuit learning is provided.

After step S601 is performed, the quantum computer 200 applies the input information provided in step S601 to the quantum circuit 210 and outputs output information (step S602). The first encoding parameter for controlling the first encoding gates of the first block circuit included in the quantum circuit 210 is set to a value based on the input information provided in step S601. The first and second learning parameters for controlling the first conversion gates and the second conversion gates of the first block circuit and the second block circuit included in the quantum circuit 210 are set to arbitrary initial values. The first gate operation layer performs a quantum gate operation on the qubits by using the first encoding gates parameterized with the first encoding parameter, thereby encoding the input information into the qubits, and constructing the first Hartree-Fock state. The first gate operation layer constructs the first quantum state by performing a quantum gate operation on the first Hartree-Fock state by using the first transformation gates parameterized with the first learning parameter. The measurement layer outputs an expected value of an observable for the first quantum state as a measured value. As the expected value of the observable, for example, an expected value of the Hamiltonian is measured.

The quantum computer 200 sets the measured value output from the measurement layer to the value of the second encoding parameter for controlling the second encoding gates of the second block circuit. The second gate operation layer performs a quantum gate operation on the qubits initialized by the initialization layer by using the second encoding gates parameterized with the second encoding parameter, thereby encoding the measured value into the qubits and constructing the second Hartree-Fock state. The second gate operation layer constructs the second quantum state by performing a quantum gate operation on the second Hartree-Fock state by using the second transformation gates parameterized with the second learning parameter. The output layer outputs the second quantum state as a trial wave function. The trial wave function is output as the output information.

After step S602 is performed, the classical computer 100 updates the learning parameter of the quantum circuit 210 based on a difference between the output information output in step S602 and ground truth information corresponding to the input information provided in step S601 (step S603). Specifically, in step S603, the learning control unit 111 updates the learning parameter using a cost function that evaluates the difference between the output information and the ground truth information. Specifically, the learning control unit 111 calculates the cost function based on the output information and the ground truth information. The cost function is defined by a sum of expected values of the Hamiltonian for the second quantum state for the number of samples of the input information. The learning control unit 111 updates the learning parameter according to a predetermined optimization method so as to reduce the cost function. As a result, the first learning parameter 226 and the second learning parameter 236 are updated so that the quantum circuit 210 constructs the accurate output information (trial wave function) 250 from the input information (molecular structure parameter) 240.

As the optimization method, the Nelder-Mead method, the Powell method, the CG method, the Newton method, the BFGS method, the L-BFGS-B method, the TNC method, the COBYLA method, and/or the SLSQP method, or any other optimization method can be used. The ground truth information is high-accuracy output information calculated based on the corresponding input information. As the ground truth information, for example, it is preferable to use an exact solution calculated by the classical computer based on the input information according to an arbitrary high-accuracy algorithm such as a full configuration interaction method (FCI) method or a complete active space CI (CASCI) method. Alternatively, an experimental result for the input information may be used as the ground truth information.

After step S603 is performed, the classical computer 100 determines whether or not to end the learning parameter update processing (step S604). Specifically, the learning control unit 111 of the classical computer 100 determines whether or not a stop condition for stopping the update processing is satisfied. The stop condition can be set to any condition such as a condition that the number of iterations of steps S601 to S604 has reached a predetermined number of times or that the function value of the cost function has reached a threshold. When the learning control unit 111 determines that the stop condition is not satisfied, that is, when the learning control unit 111 determines that the update processing is not to be ended (step S604: NO), steps S601 to S604 are repeated for another sample.

When the learning control unit 111 determines that the stop condition is satisfied, that is, when the learning control unit 111 determines to end the learning parameter update processing (step S604: YES), the classical computer 100 determines the learning parameter (step S605). The quantum circuit 210 in which the determined learning parameter is set is implemented as a learned quantum circuit in the quantum inference system to be described later.

As a result, the quantum circuit learning processing by the quantum circuit learning system 1 ends.

The quantum circuit learning system 1 is an example, and a change, addition, and/or removal can be appropriately made in the quantum circuit learning system 1 without departing from the gist of the invention. As an example, as illustrated in FIG. 1, the quantum circuit learning system 1 includes the classical computer 100 and the quantum computer 200. However, the present embodiment is not limited thereto, and the classical computer 100 may be incorporated into the quantum computer 200, or the quantum computer 200 may be incorporated into the classical computer 100.

As another example, in FIG. 3 and the like, the measurement layer 222 performs the measurement on any one qubit of the first qubit, the second qubit, the third qubit, and the fourth qubit, but the measurement layer 222 may perform the measurement on a combination of any two or three of the qubits, or may perform the measurement on all of the first qubit, the second qubit, the third qubit, and the fourth qubit. As another example, in FIG. 2 and the like, in the quantum circuit 210, the second block circuit 230 has the second gate operation layer 231 and the output layer 232, but one or a plurality of blocks each including a measurement layer 222 and a second gate operation layer 231 may be concatenated between the second gate operation layer 231 and the output layer 232. In this case, the plurality of second gate operation layers 231 are concatenated via measured values of the immediately preceding measurement layers 222. In other words, the measured values of the immediately preceding measurement layers 222 are set as the first encoding parameters of the second gate operation layers 231. This makes it possible to handle complex quantum chemistry computing.

### Quantum Inference System

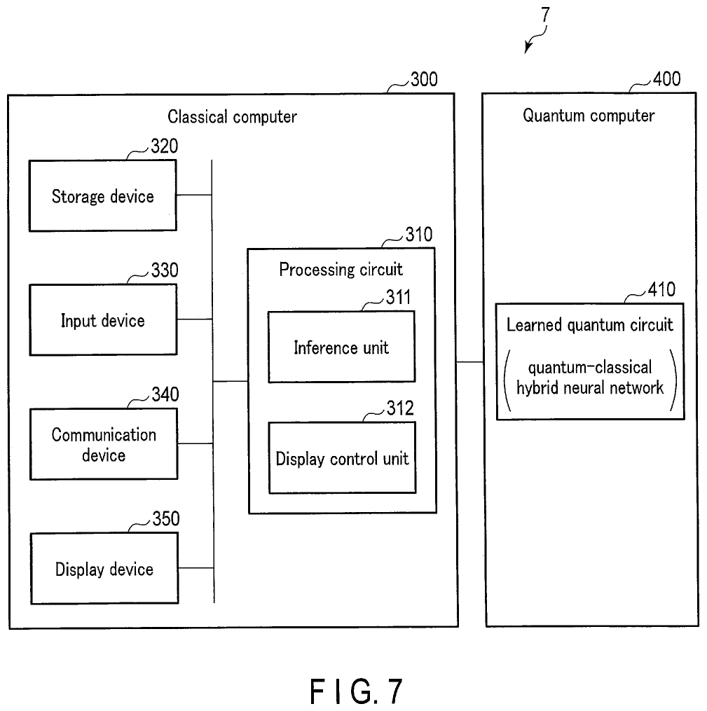

FIG. 7 is a diagram illustrating an example of a configuration of the quantum inference system 7 according to the present embodiment. As illustrated in FIG. 7, the quantum inference system 7 includes a classical computer 300 and a quantum computer 400. The classical computer 300 and the quantum computer 400 are connected to each other so as to be able to communicate information with each other by wire or wirelessly.

The classical computer 300 is a computer that processes binary classical bits. The classical computer 300 is a computer including a processing circuit 310, a storage device 320, an input device 330, a communication device 340, and a display device 350. Information communication is performed between the processing circuit 310, the storage device 320, the input device 330, the communication device 340, and the display device 350 via a bus.

The processing circuit 310 includes a processor such as a CPU and a memory such as a RAM. The processing circuit 310 includes an inference unit 311 and a display control unit 312. The processing circuit 310 executes a quantum inference program to implement each function of the units 311 and 312 described above. The quantum inference program is stored in a non-transitory computer-readable recording medium such as the storage device 320. The quantum circuit learning program may be implemented as a single program that describes all the functions of the units 311 and 312 described above, or may be implemented as a plurality of modules divided into several functional units. Each of the units 311 and 312 may be implemented by an integrated circuit such as an ASIC or an FPGA. In this case, the units 111 to 114 may be mounted on a single integrated circuit, or may be individually mounted on a plurality of integrated circuits.

The inference unit 311 controls quantum inference processing using a learned quantum circuit 410 implemented in the quantum computer 400. Specifically, the inference unit 311 acquires input information to be processed. The inference unit 311 provides the input information to be processed to the learned quantum circuit 410. The input information is transformed into inference result information by the learned quantum circuit 410. The inference result information is output information constructed by the learned quantum circuit 410.

The display control unit 312 displays various types of information on the display device 350. For example, the display control unit 312 displays the input information, the inference result information, and the like.

The storage device 320 includes a ROM, an HDD, an SSD, an integrated circuit storage device, or the like. The storage device 320 stores the quantum inference program and the like.

The input device 330 inputs various commands from an operator. As the input device 330, a keyboard, a mouse, various switches, a touch pad, a touch panel display, and the like can be used. An output signal from the input device 330 is supplied to the processing circuit 310. Various commands from the operator may be input not by the input device 330 included in the classical computer 300 but by an input device provided in another classical computer connected via the communication device 340.

The communication device 340 is an interface for performing information communication with an external device such as the quantum computer 400 connected to the classical computer 300 by wire or wirelessly.

The display device 350 displays various types of information under control by the display control unit 312. As the display device 350, a CRT display, a liquid crystal display, an organic EL display, an LED display, a plasma display, or any other display known in the art can be appropriately used. Furthermore, the display device 350 may be a projector.

The quantum computer 400 is a computer that has the learned quantum circuit 410 implemented therein that performs a quantum gate operation on a plurality of qubits and performs quantum computing using the learned quantum circuit 410. The learned quantum circuit 410 is the quantum circuit 210 trained by the quantum circuit learning system 1. That is, the learning parameter determined in step S605 in FIG. 6 is set in the learned quantum circuit 410.

The quantum computer 400 receives the input information to be processed from the classical computer 300, and inputs the input information to the learned quantum circuit 410 that performs a quantum gate operation on a plurality of qubits. The learned quantum circuit 410 transforms the input information into inference result information. The quantum computer 400 acquires the inference result information from the learned quantum circuit 410. The quantum computer 400 transmits the acquired inference result information to the classical computer 300. A hardware configuration of the quantum computer 400 is similar to that of the quantum computer 200 of the quantum circuit learning system 1.

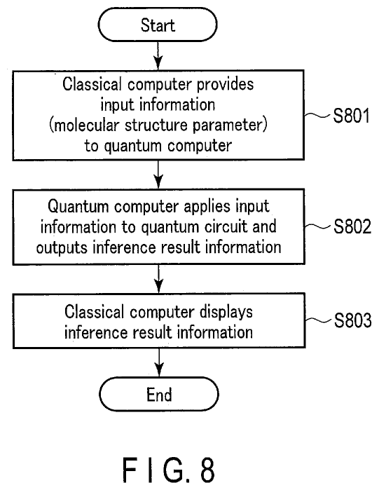

FIG. 8 is a diagram illustrating a processing procedure of the quantum inference processing by the quantum inference system 7. As illustrated in FIG. 8, the classical computer 300 provides input information to be processed to the quantum computer 400 (step S801). As the input information, a molecular structure parameter of the processing target molecule is provided.

After step S801 is performed, the quantum computer 400 applies the input information provided in step S801 to the learned quantum circuit 410 and outputs inference result information (step S802). The first encoding parameter for controlling the first encoding gates of the first block circuit included in the learned quantum circuit 410 is set to a value based on the input information provided in step S801. The first and second learning parameters for controlling the first transformation gates and the second transformation gates of the first block circuit and the second block circuit included in the learned quantum circuit 410 are set to the first learning parameter (hereinafter, a first determined parameter) and the second learning parameter (hereinafter, a second determined parameter) determined in step S605, respectively. The first gate operation layer performs a quantum gate operation on the qubits by using the first encoding gates parameterized with the first encoding parameter, thereby encoding the qubits into the input information and constructing the first Hartree-Fock state. The first gate operation layer constructs the first quantum state by performing a quantum gate operation on the first Hartree-Fock state by using the first transformation gates parameterized with the first determined parameter. The measurement layer outputs an expected value of an observable for the first quantum state as a measured value.

The quantum computer 400 sets the measured value output from the measurement layer to the value of the second encoding parameter that controls the second encoding gates of the second block circuit. The second gate operation layer performs a quantum gate operation on the qubits initialized by the initialization layer by using the second encoding gates parameterized with the second encoding parameter, thereby encoding the measured value into the qubits and constructing the second Hartree-Fock state. The second gate operation layer constructs the second quantum state by performing a quantum gate operation on the second Hartree-Fock state by using the second transform gates parameterized with the second determined parameter. The output layer outputs the second quantum state as a trial wave function. The trial wave function is output as the inference result information.

After step S802 is performed, the classical computer 300 displays the inference result information (step S803). Furthermore, the classical computer 300 may calculate secondary information such as potential energy and a Hellmann Feynman force based on the inference result information. The inference result information and the secondary information are displayed in a predetermined layout on the display device 350.

As a result, the quantum inference processing by the quantum inference system 7 ends.

The quantum inference system 7 is an example, and a change, addition, and/or removal can be appropriately made in the quantum inference system 7 without departing from the gist of the invention. As an example, as illustrated in FIG. 7, the quantum inference system 7 includes the classical computer 300 and the quantum computer 400. However, the present embodiment is not limited thereto, and the classical computer 300 may be incorporated into the quantum computer 400, or the quantum computer 400 may be incorporated into the classical computer 300.

Hereinafter, examples of the quantum chemistry computing according to the present embodiment will be described.

### Example 1

A processing target molecule according to Example 1 is an H₂ molecule. Numerical simulation was performed using the electron Hamiltonian of the H₂ molecule. In Example 1, the Hamiltonian was calculated using existing open source libraries PySCF (see Reference 1 (Q. Sun, T. C. Berkelbach, N. S. Blunt, G. H. Booth, S. Guo, Z. Li, J. Liu, J. D. McClain, E. R. Sayfutyarova, S. Sharma, S. Wouters, and G. K. Chan, Wiley Interdisciplinary Reviews: Computational Molecular Science 8, e1340 (2017))) and OpenFermion (see Reference 2 (J. R. McClean, K. J. Sung, I. D. Kivlichan, Y. Cao, C. Dai, E. S. Fried, C. Gidney, B. Gimby, P. Gokhale, T. Hner, T. Hardikar, V. Havlek, O. Higgott, C. Huang, J. Izaac, Z. Jiang, X. Liu, S. McArdle, M. Neeley, T. O'Brien, B. O'Gorman, I. Ozdan, M. D. Radin, J. Romero, N. Rubin, N. P. D. Sawaya, K. Setia, S. Sim, D. S. Steiger, M. Steudtner, Q. Sun, W. Sun, D. Wang, F. Zhang, and R. Babbush, (2017), arXiv: 1710.07629.). The simulation of the quantum circuit was performed using Qiskit (Reference 3 (see G. Aleksandrowicz, T. Alexander, P. Barkoutsos, L. Bello, Y. Ben-Haim, D. Bucher, F. Jose Cabrera-Hernandez, J. Carballo-Franquis, A. Chen, C. Chen, J. Chow, A. Corcoles-Gonzales, A. Cross, A. Cross, A. Cross, J. Cruz-Benito, C. Culver, S. Gonzalez, E. Torre, D, Ding, E. Dumitrescu, I. Duran, P. Eendebak, M. Everitt, I. Sertage, A. Frisch, A. Fuhrer, J. Gambetta, B Gago, J. Gomez-Mosquera, D. Greenberg, I. Hamamura, V. Havlicek, J. Hellmers, L. Herok, H. Horii, S. Hu, T. Imamichi, T. Itoko, A. Javadi-Abhari, N. Kanazawa, A. Karazeev, K. Krsulich, P. Liu, Y. Luh, Y. Maeng, M. Marques, F. Martin-Fernandez, D. McClure, D. McKay, S. Meesala, A. Mezzacapo, N. Moll, D. Rodriguez, G. Nannicini, P. Nation, P. Ollitrault, L. O'Riordan, H. Paik, J. Perez, A. Phan, M. Pistoia, V. Prutyanov, M. Reuter, J. Rice, A. Davila, R. Rudy, M. Ryu, N. Sathaye, C. Schnabel, E. Schoute, K. Setia, Y. Shi, A. Silva, Y. Siraichi, S. Sivarajah, J. Smolin, M. Soeken, H. Takahashi, I. Tavernelli, C. Taylor, P. Taylour, K. Trabing, M. Treinish, W. Turner, D. Vogt-Lee, C. Vuillot, J. Wildstrom, J. Wilson, E. Winston, C. Wood, S. Wood, S. Worner, I. Akhalwaya, C. Zoufalhttps. https://doi.org/10.5281/zenodo.2562111, (2019) An Open-source Framework for Quantum Computing)).

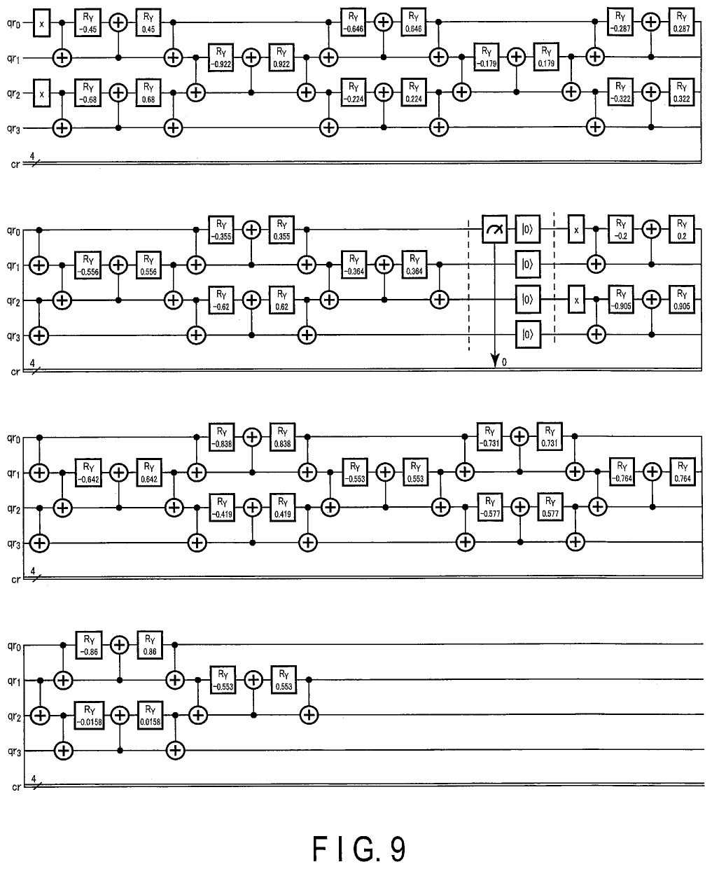

FIG. 9 is a schematic diagram of a circuit configuration of a quantum circuit (hereinafter, referred to as a quantum circuit QC1) according to Example 1 in quantum gate notation. The quantum circuit QC1 has a configuration in which a quantum gate operation is performed on four qubits, and SYMC blocks illustrated in FIGS. 4 and 5 are concatenated to each of a first block circuit and a second block circuit. Note that “Ry” illustrated in FIG. 9 represents a y-axis rotation gate, and a gate arranged across two qubits is a CNOT gate.

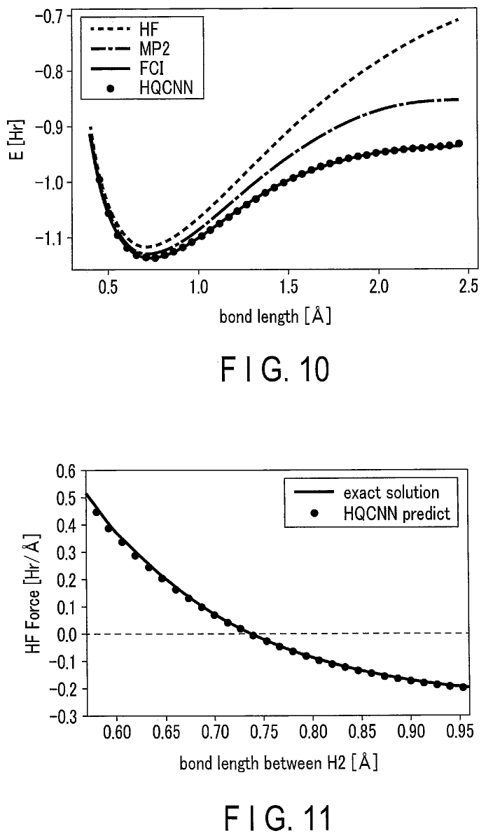

FIG. 10 is a graph illustrating numerical simulation results according to Example 1. In the graph illustrated in FIG. 10, the vertical axis is defined by the potential energy E [Hr], and the horizontal axis is defined by the bond length [A]. In Example 1, the learned quantum circuit QC1 was constructed by using bond lengths (interatomic distance) between the hydrogen atoms as an encoding parameter to update a learning parameter of the quantum circuit QC1. Thereafter, potential energy for each of the plurality of bond lengths as the encoding parameter was inferred using the learned quantum circuit QC1. The potential energy is calculated by the inference unit 311 of the classical computer 300 based on a trial wave function output from the learned quantum circuit QC1. A curved surface formed by the potential energy for each bond length is called a potential energy surface (PES).

HF (Hartree-Fock), MP2 (Moller-Plesset 2), and FCI in FIG. 10 mean potential energy surfaces by Hartree-Fock approximation, MP2 method (perturbation method), and Full-CI method, respectively. Each of HF, MP2, and FCI is calculated based on a trial wave function calculated by the classical computer without using the quantum circuit QC1. FCI is an exact solution with the highest calculation accuracy. HQCNN is the result of the potential energy surface calculated using the quantum circuit QC1. As illustrated in FIG. 10, according to HQCNN, it can be seen that it is possible to infer the result of the exact solution FCI obtained using the classical computer with high accuracy.

FIG. 11 is another graph illustrating numerical simulation results according to Example 1. In the graph illustrated in FIG. 11, the vertical axis is defined by the Hellmann Feynman force (HF Force) [Hr/Å], and the horizontal axis is defined by the bond length [Å] between hydrogen atoms (H₂). The Hellmann-Feynman force is a force acting on the hydrogen atoms obtained from coordinate differentiation of energy based on the Hellmann-Feynman theorem. HQCNN predict illustrated in FIG. 11 is results of inference based on the trial wave function obtained by the quantum circuit QC1. The exact solution is calculated based on a trial wave function calculated by the classical computer without using the quantum circuit QC1. As illustrated in FIG. 11, according to HQCNN predict, it can be seen that it is possible to accurately infer the Hellmann-Feynman power.

As described above, by using the quantum circuit QC1 according to the present embodiment, the energy and the force acting on the atoms can be inferred with high accuracy. Therefore, the quantum circuit QC1 can be applied to a simulation technique for performing molecular dynamics calculation represented by molecular dynamics.

### Example 2

Processing target molecules according to Example 2 are an H₂O molecule and an NH₃ molecule. In Example 2, 4-qubit calculation using a model of a complete active space cas(2e, 2o) was performed. In Example 2, numerical simulation was performed using the same open source libraries as in Example 1.

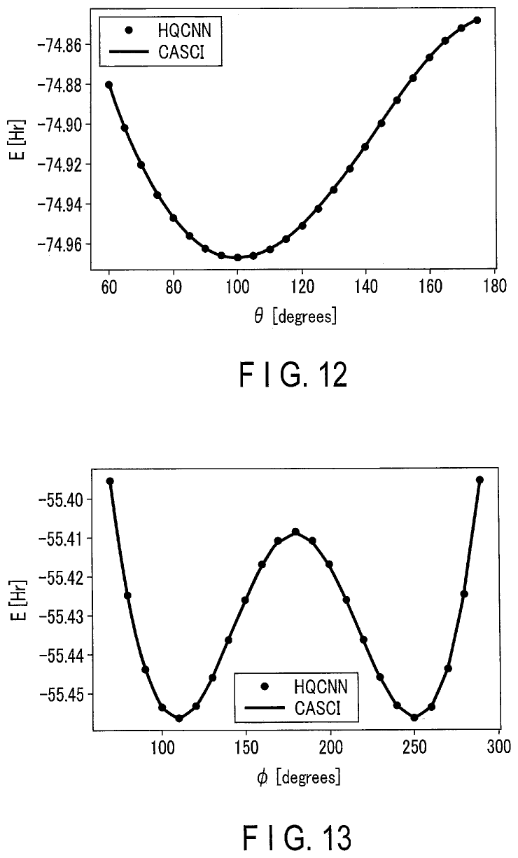

FIG. 12 is a graph illustrating numerical simulation results of the H₂O molecule according to Example 2. In the graph illustrated in FIG. 12, the vertical axis is defined by the potential energy E [Hr], and the horizontal axis is defined by the bond angle θ [degrees]. The bond angle θ means an H—O—H bond angle formed between the two hydrogen atoms and the oxygen atom of the H₂O molecule. In Example 2, a learned quantum circuit QC1 is constructed by using bond angles as an encoding parameter to update a learning parameter of the quantum circuit QC1. Thereafter, potential energy for each of the plurality of bond angles as the encoding parameter was inferred using the learned quantum circuit QC1. The potential energy is calculated by the inference unit 311 of the classical computer 300 based on a trial wave function output from the learned quantum circuit QC1. A curved surface formed by the potential energy for each bond angle is called a potential energy surface (PES).

FIG. 13 is a graph illustrating numerical simulation results of the NH₃ molecule according to Example 2. In the graph illustrated in FIG. 13, the vertical axis is defined by the potential energy E [Hr], and the horizontal axis is defined by the improper dihedral angle φ [degrees] of the NH₃ molecule. In Example 2, a learned quantum circuit QC1 is constructed by using bond angles as an encoding parameter to update a learning parameter of the quantum circuit QC1. Thereafter, potential energy for each of the plurality of bond angles as the encoding parameter was inferred using the learned quantum circuit QC1. The potential energy is calculated by the inference unit 311 of the classical computer 300 based on a trial wave function output from the learned quantum circuit QC1.

CASCI in FIGS. 12 and 13 is an exact solution using the classical computer in the model of the complete active space cas(2e, 2o). HQCNN is the result of the potential energy surface according to Example 2. FIGS. 12 and 13 illustrate the result of the potential energy surface obtained using the result CASCI from the classical computer in the model of the complete active space cas(2e, 2o) and the result HQCNN in Example 2.

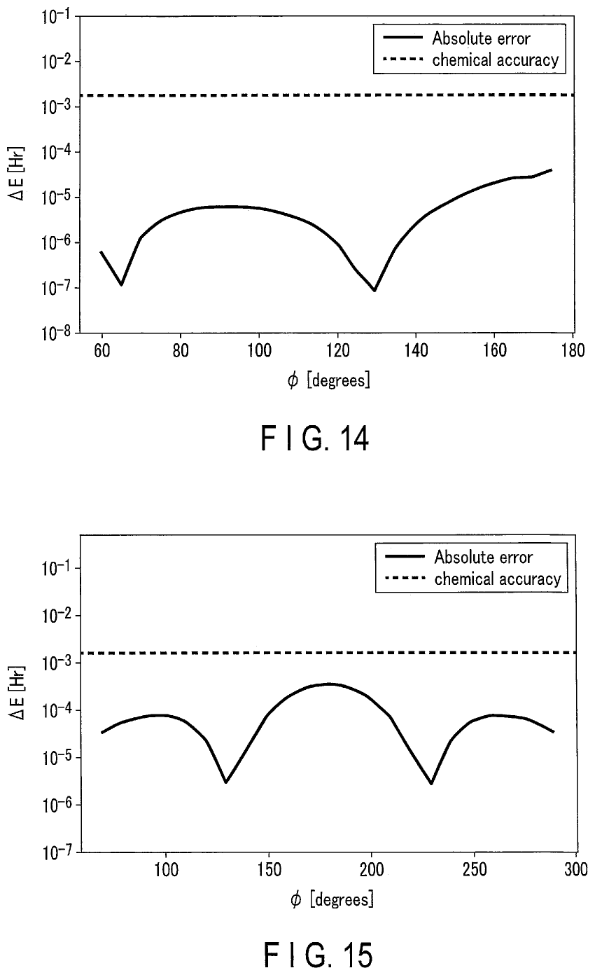

FIG. 14 is a graph illustrating an error (absolute error) between the numerical simulation results of the H₂O molecule by CASCI illustrated in FIG. 12 and the numerical simulation results of the H₂O molecule by HQCNN illustrated in FIG. 12. FIG. 15 is a graph illustrating an absolute error (absolute error) between the numerical simulation results of the NH₃ molecule by CASCI illustrated in FIG. 13 and the numerical simulation results of the NH₃ molecule by HQCNN illustrated in FIG. 13. Dotted lines in FIGS. 14 and 15 indicate a value of chemical accuracy, 1 kcal/mol≈1.593×10⁻³ Hr, and it is desirable that the errors fall within the chemical accuracy or less. According to HQCNN, it can be seen that it is possible to infer the result of the exact solution CASCI obtained using the classical computer with high accuracy.

### Example 3

A processing target molecule according to Example 3 is an H₃ molecule. In Example 3, a quantum circuit (hereinafter, referred to as a quantum circuit QC3) that performs a quantum gate operation on 6 qubits was used. The quantum circuit QC3 was obtained by increasing the number of qubits of the quantum circuit QC1 illustrated in FIG. 9 from 4 to 6. In Example 3, numerical simulation was performed using the same open source libraries as in Example 1.

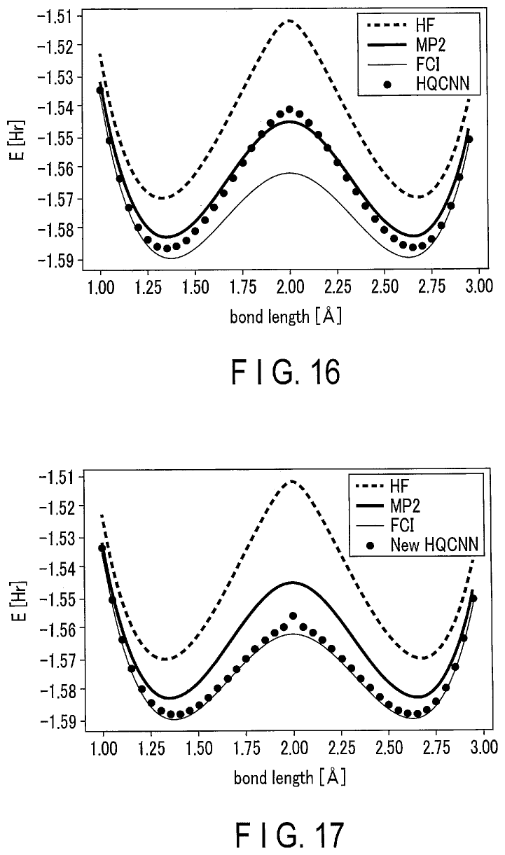

FIG. 16 is a graph illustrating numerical simulation results of the H₃ molecule according to a comparative example of Example 3. FIG. 17 is a graph illustrating numerical simulation results of the H₃ molecule according to Example 3. In the graphs illustrated in FIGS. 16 and 17, the vertical axis is defined by the potential energy E [Hr], and the horizontal axis is defined by a bond length [Å]. The bond length according to Example 3 is a bond length between a first hydrogen atom and a second hydrogen atom among three hydrogen atoms constituting the H₃ molecule arranged one-dimensionally. In Example 3, the learned quantum circuit QC3 was constructed by using bond lengths (interatomic distances) between the hydrogen atoms as an encoding parameter to update a learning parameter of the quantum circuit QC3. Thereafter, potential energy for each of the plurality of bond lengths as the encoding parameter was inferred using the learned quantum circuit QC3. Specifically, the coordinates of the first hydrogen atom, the second hydrogen atom, and the third hydrogen atom were defined as [0, 0, 0], [xa₀, 0, 0], and [4a₀, 0, 0], respectively, and the variable x was changed at predetermined distance intervals between 1.0 and 3.0 to change the bond lengths. a₀ is the Bohr radius (=0.529 Å). The potential energy is calculated by the inference unit 311 of the classical computer 300 based on a trial wave function output from the learned quantum circuit QC3.

HQCNN in FIG. 16 is a potential energy surface calculated using the quantum-classical hybrid neural network described in Non-Patent Literature 2. New HQCNN in FIG. 17 is a potential energy surface calculated using the learned quantum circuit QC3 according to Example 3. As illustrated in FIGS. 16 and 17, according to New HQCNN, it can be seen that it is possible to infer the result of an exact solution FCI by the classical computer with higher accuracy than the HQCNN described in Non-Patent Literature 2.

Thus, according to the present embodiment, it is possible to provide a quantum circuit learning system, a quantum circuit learning method, a quantum circuit learning program, a quantum inference system, a quantum circuit, and a quantum-classical hybrid neural network that achieve high inference accuracy at low calculation cost.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

Hereinafter, the invention disclosed in the specification and claims at the time of filing of the present application will be appended.

(1) A quantum circuit learning system includes:
a quantum computer that applies input information to a quantum circuit that performs a quantum gate operation on a plurality of qubits to acquire output information corresponding to the input information; and
a classical computer that updates a learning parameter of the quantum circuit based on a difference between the output information and ground truth information.

The quantum circuit includes a first block circuit and a second block circuit concatenated to the first block circuit. The first block circuit includes: a first gate operation layer including a first encoding gate that is a quantum gate parameterized with a first encoding parameter in which the input information is encoded and which is for constructing a first Hartree-Fock state, and a first transformation gate that is a quantum gate parameterized with the learning parameter for transforming the first Hartree-Fock state into a first quantum state; and a measurement layer that outputs a measured value of the first quantum state.

The second block circuit includes: a second gate operation layer including a second encoding gate parameterized with a second encoding parameter in which the measured value is encoded and which is for constructing a second Hartree-Fock state, and a second transformation gate parameterized with the learning parameter for transforming the second Hartree-Fock state into a second quantum state; and an output layer that outputs the second quantum state as the output information.

(2) The quantum circuit learning system according to (1), in which
the measurement layer outputs an expected value of an observable for the first quantum state as the measured value, and the quantum computer sets the measured value to the second encoding parameter for the second encoding gate.

(3) The quantum circuit learning system according to (2), in which the output layer outputs the second quantum state as a trial wave function.

(4) The quantum circuit learning system according to (2) or (3), in which the first block circuit and/or the second block circuit preserves the number of particles represented by the plurality of qubits.

(5) The quantum circuit learning system according to any one of (1) to (4), in which the classical computer updates the learning parameter using a cost function for evaluating the difference.

(6) The quantum circuit learning system according to (5), in which the cost function is defined by a sum of expected values of a Hamiltonian for the second quantum state for the number of samples of the input information.

(7) The quantum circuit learning system according to any one of (1) to (6), in which the classical computer updates the learning parameter according to a Nelder-Mead method, a Powell method, a CG method, a Newton method, a BFGS method, an L-BFGS-B method, a TNC method, a COBYLA method, or an SLSQP method.

(8) The quantum circuit learning system according to any one of (1) to (7), in which the learning parameter is a rotation angle parameter representing a rotation angle of a rotation gate out of the first transformation gate and the second transformation gate.

(9) The quantum circuit learning system according to any one of (1) to (8), in which the first gate operation layer and the second gate operation layer have different quantum gate configurations.

(10) The quantum circuit learning system according to any one of (1) to (9), in which
the input information is a molecular structure parameter that defines a molecular structure of a target molecule, and
the output information is a trial wave function.

(11) A quantum circuit learning method includes:
applying input information to a quantum circuit that performs a quantum gate operation on a plurality of qubits to acquire output information corresponding to the input information; and
updating a learning parameter of the quantum circuit based on a difference between the output information and ground truth information.

The quantum circuit includes a first block circuit and a second block circuit concatenated to the first block circuit.

The first block circuit includes: a first gate operation layer including a first encoding gate that is a quantum gate parameterized with a first encoding parameter in which the input information is encoded and which is for constructing a first Hartree-Fock state, and a first transformation gate that is a quantum gate parameterized with the learning parameter for transforming the first Hartree-Fock state into a first quantum state; and a measurement layer that outputs a measured value of the first quantum state.

The second block circuit includes: a second gate operation layer including a second encoding gate parameterized with a second encoding parameter in which the measured value is encoded and which is for constructing a second Hartree-Fock state, and a second transformation gate parameterized with the learning parameter for transforming the second Hartree-Fock state into a second quantum state; and an output layer that outputs the second quantum state as the output information.

The inventions of (2) to (10) described above can be applied to the quantum circuit learning method.

(12) A quantum inference system includes a quantum computer that applies input information to a quantum circuit that performs a quantum gate operation on a plurality of qubits to acquire output information corresponding to the input information.

The quantum circuit includes a first block circuit and a second block circuit concatenated to the first block circuit.

The first block circuit includes: a first gate operation layer including a first encoding gate that is a quantum gate parameterized with a first encoding parameter in which the input information is encoded and which is for constructing a first Hartree-Fock state, and a first transformation gate that is a quantum gate parameterized with a learning parameter for transforming the first Hartree-Fock state into a first quantum state; and a measurement layer that outputs a measured value of the first quantum state.

The second block circuit includes: a second gate operation layer including a second encoding gate parameterized with a second encoding parameter in which the measured value is encoded and which is for constructing a second Hartree-Fock state, and a second transformation gate parameterized with the learning parameter for transforming the second Hartree-Fock state into a second quantum state; and an output layer that outputs the second quantum state as the output information.

The inventions of (2) to (10) described above can be applied to the quantum inference system.

(13) A quantum circuit includes
a first block circuit and a second block circuit concatenated to the first block circuit.

The first block circuit includes: a first gate operation layer including a first encoding gate that is a quantum gate parameterized with a first encoding parameter in which input information is encoded and which is for constructing a first Hartree-Fock state, and a first transformation gate that is a quantum gate parameterized with a learning parameter for transforming the first Hartree-Fock state into a first quantum state; and a measurement layer that outputs a measured value of the first quantum state.

The second block circuit includes: a second gate operation layer including a second encoding gate parameterized with a second encoding parameter in which the measured value is encoded and which is for constructing a second Hartree-Fock state, and a second transformation gate parameterized with the learning parameter for transforming the second Hartree-Fock state into a second quantum state; and an output layer that outputs the second quantum state as output information.

The inventions of (2) to (10) described above can be applied to the quantum circuit.

(14) A quantum-classical hybrid neural network includes a repetitive structure of block circuits each including a quantum circuit in which quantum information undergoes processing in an order of a Hartree-Fock state construction, a parameterized quantum circuit processing, and a measurement layer processing.

The inventions of (2) to (10) described above can be applied to the quantum-classical hybrid neural network.

What is claimed is:

1. A quantum circuit learning system comprising:
a quantum computer configured to apply input information to a quantum circuit that performs a quantum gate operation on a plurality of qubits to acquire output information corresponding to the input information; and
a classical computer configured to update a learning parameter of the quantum circuit based on a difference between the output information and ground truth information, wherein
the quantum circuit includes a first block circuit and a second block circuit concatenated to the first block circuit,
the first block circuit includes: a first gate operation layer including a first encoding gate that is a quantum gate parameterized with a first encoding parameter in which the input information is encoded and which is for constructing a first Hartree-Fock state, and a first transformation gate that is a quantum gate parameterized with the learning parameter for transforming the first Hartree-Fock state into a first quantum state; and a measurement layer that outputs a measured value of the first quantum state, and
the second block circuit includes: a second gate operation layer including a second encoding gate parameterized with a second encoding parameter in which the measured value is encoded and which is for constructing a second Hartree-Fock state, and a second transformation gate parameterized with the learning parameter for transforming the second Hartree-Fock state into a second quantum state; and an output layer that outputs the second quantum state as the output information.

2. The quantum circuit learning system according to claim 1, wherein
the measurement layer outputs an expected value of an observable for the first quantum state as the measured value, and
the quantum computer sets the measured value to the second encoding parameter for the second encoding gate.

3. The quantum circuit learning system according to claim 2, wherein the output layer outputs the second quantum state as a trial wave function.

4. The quantum circuit learning system according to claim 1, wherein the first block circuit and/or the second block circuit preserves the number of particles represented by the plurality of qubits.

5. The quantum circuit learning system according to claim 1, wherein the classical computer updates the learning parameter using a cost function for evaluating the difference.

6. The quantum circuit learning system according to claim 5, wherein the cost function is defined by a sum of expected values of a Hamiltonian for the second quantum state for the number of samples of the input information.

7. The quantum circuit learning system according to claim 1, wherein the classical computer updates the learning parameter according to a Nelder-Mead method, a Powell method, a CG method, a Newton method, a BFGS method, an L-BFGS-B method, a TNC method, a COBYLA method, or an SLSQP method.

8. The quantum circuit learning system according to claim 1, wherein the learning parameter is a rotation angle parameter representing a rotation angle of a rotation gate out of the first transformation gate and the second transformation gate.

9. The quantum circuit learning system according to claim 1, wherein the first gate operation layer and the second gate operation layer have different quantum gate configurations.

10. The quantum circuit learning system according to claim 1, wherein
the input information is a molecular structure parameter that defines a molecular structure of a target molecule, and
the output information is a trial wave function.

11. A quantum circuit learning method comprising:
applying input information to a quantum circuit that performs a quantum gate operation on a plurality of qubits to acquire output information corresponding to the input information; and
updating a learning parameter of the quantum circuit based on a difference between the output information and ground truth information, wherein
the quantum circuit includes a first block circuit and a second block circuit concatenated to the first block circuit,
the first block circuit includes: a first gate operation layer including a first encoding gate that is a quantum gate parameterized with a first encoding parameter in which the input information is encoded and which is for constructing a first Hartree-Fock state, and a first transformation gate that is a quantum gate parameterized with the learning parameter for transforming the first Hartree-Fock state into a first quantum state; and a measurement layer that outputs a measured value of the first quantum state, and
the second block circuit includes: a second gate operation layer including a second encoding gate parameterized with a second encoding parameter in which the measured value is encoded and which is for constructing a second Hartree-Fock state, and a second transformation gate parameterized with the learning parameter for transforming the second Hartree-Fock state into a second quantum state; and an output layer that outputs the second quantum state as the output information.

12. A quantum inference system comprising a quantum computer configured to apply input information to a quantum circuit that performs a quantum gate operation on a plurality of qubits to acquire output information corresponding to the input information, wherein
the quantum circuit includes a first block circuit and a second block circuit concatenated to the first block circuit,
the first block circuit includes: a first gate operation layer including a first encoding gate that is a quantum gate parameterized with a first encoding parameter in which the input information is encoded and which is for constructing a first Hartree-Fock state, and a first transformation gate that is a quantum gate parameterized with a learning parameter for transforming the first Hartree-Fock state into a first quantum state; and a measurement layer that outputs a measured value of the first quantum state, and
the second block circuit includes: a second gate operation layer including a second encoding gate parameterized with a second encoding parameter in which the measured value is encoded and which is for constructing a second Hartree-Fock state, and a second transformation gate parameterized with the learning parameter for transforming the second Hartree-Fock state into a second quantum state; and an output layer that outputs the second quantum state as the output information.

13. A quantum circuit comprising:
a first block circuit; and a second block circuit concatenated to the first block circuit, wherein
the first block circuit includes: a first gate operation layer including a first encoding gate that is a quantum gate parameterized with a first encoding parameter in which input information is encoded and which is for constructing a first Hartree-Fock state, and a first transformation gate that is a quantum gate parameterized with a learning parameter for transforming the first Hartree-Fock state into a first quantum state; and a measurement layer that outputs a measured value of the first quantum state, and
the second block circuit includes: a second gate operation layer including a second encoding gate parameterized with a second encoding parameter in which the measured value is encoded and which is for constructing a second Hartree-Fock state, and a second transformation gate parameterized with the learning parameter for transforming the second Hartree-Fock state into a second quantum state; and an output layer that outputs the second quantum state as output information.

14. A quantum-classical hybrid neural network comprising a repetitive structure of block circuits each comprising a quantum circuit in which quantum information undergoes processing in an order of a Hartree-Fock state construction, a parameterized quantum circuit processing, and a measurement layer processing.
